(19) United States
(12) Patent Application Publication
(10) Pub. No.: US 2013/0120750 A1
(43) Pub. Date: May 16, 2013

(54) OPTICAL PHASE DEVICE, METHOD AND SYSTEM

(71) Applicant: BEIHANG UNIVERSITY, Beijing (CN)

(72) Inventors: Zheng Zheng, Beijing (CN); Wan Yuhang, Beijing (CN); Zhao Xin, Beijing (CN); Lv Zhiting, Beijing (CN); Guan Jingyi, Beijing (CN)

(73) Assignee: BEIHANG UNIVERSITY, Bejing (CN)

(21) Appl. No.: 13/737,318

(22) Filed: Jan. 9, 2013

Related U.S. Application Data
(63) Continuation-in-part of application No. 13/809,061, filed on Jan. 8, 2013.

(30) Foreign Application Priority Data
May 20, 2011 (CN) 201110132978

(51) Int. Cl. G01J 4/00

(52) U.S. Cl. CPC G01J 4/00
USPC 356/364

(57) ABSTRACT

The invention provides an optical phase device with its application method and system. The optical phase device consists of a transparent dielectric substrate, a multilayer stack of dielectrics and a buffer layer. The refractive index of the transparent dielectric substrate, the multilayer stack of dielectrics and the buffer layer are all larger than that of the external medium. For the wavelength of the incident beam, the optical phase device has a phase variation in the angular range [α, β] and the critical angle for total reflection on the interface between the buffer layer and the external medium adjacent to the buffer layer is γ, γ>β. Our invention of the optical device has both low loss and large phase variation, which leads to a large Goos-Hanchen shift. As a dispersion compensation component, it can produce bigger and tunable dispersion, and different dispersion compensations can be got by adjusting the operating angle or parameters in the structure.

### PRIORITY CLAIM

This application is a continuation in part of U.S. patent application Ser. No. 13/809,061 titled “AN OPTICAL PHASE DEVICE, METHOD AND SYSTEM” by Zheng Zheng et al., filed Jan. 8, 2013 which is the national phase application of and claims priority to PCT Patent Application No. PCT/CN2011/001705 which published as WO2012159238, titled “OPTICAL PHASE DEVICE AS WELL AS APPLICATION METHOD AND SYSTEM THEREOF” by Zheng Zheng et al., filed Oct. 12, 2011, which claims priority to Chinese application No. 20110132978.X filed May 20, 2011, the specification and drawings of which are all herein expressly incorporated by reference in their entireties.

### FIELD OF THE INVENTION

This invention involves sensing technology and dispersion compensation technology, especially involving an optical phase device with its application method and system.

### BACKGROUND OF THE INVENTION

When the beam is reflected on the interface of which the refractivity is (including intensity and phase) not constant, a number of non-specular reflection phenomenon may happen. For example, there may exist a certain lateral displacement between the incident point and the emergent point of the beam center on the reflection interface. This phenomenon was first experimentally confirmed by Goos and Hanchen, thus, it was named the Goos-Hanchen effect. Other possible effects of non-specular reflection which may happen at the same time include longitudinal displacement (Imbert-Fedorov shift), angular rotation and beam shape change. As a typical effect of the non-specular reflection, the Goos-Hanchen effect became a hot research spot since it was found and was thoroughly studied in recent decades. Researches show that the Goos-Hanchen effect is the result of the phase's variation related to the angle of the reflectivity function. For quasi-collimated beams, the Goos-Hanchen shift is determined by the first-order derivative of the phase's variation related to the angle the beam experienced when reflected. Usually, this phase variation is so small that the Goos-Hanchen shift is only at the order of wavelength and often can be ignored. Recent research shows that by choosing materials such as absorbing material including metals and left-handed materials, the Goos-Hanchen effect can be enhanced. Previous studies also found that when the total internal reflection occurs on the interface of two materials, the phase as well as the intensity of the reflectivity changes significantly near the critical angle of the total reflection, so that the Goos-Hanchen effect can take place. Also the Goos-Hanchen effect in the structures where the evanescent wave can be excited, such as surface plasmon resonance structures, metal-coated optical waveguide structures, double-prism structures have been widely studied.

In recent years, theoretical and experimental researches on the Goos-Hanchen effect in the structures with metal have made considerable progress, and have begun to be applied in sensing field. Yin et al studied the surface plasmon resonance sensor and pointed out that when the surface plasmon resonance occurred, the reflected light had not only a sharp decrease in intensity and but also a phase variation, which can enhance the Goos-Hanchen shift. They suggested that the detection sensitivity of the surface plasmon resonance sensor can be improved by utilizing the Goos-Hanchen effect (Applied Physics Letters, 89 (2006) pp. 261108). This method converts the concentration change of the liquid sample into a refractive index change and then into surface plasmon resonance condition change, which leads to the phase variations of the reflected light and an enhanced Goos-Hanchen shift change in the Surface Plasmon Resonance (SPR) structure. And the refractive index change of the test sample can be determined by detecting the change of the Goos-Hanchen shift caused by the concentration change. Lin Chen et al used a similar method by detecting the change of the enhanced Goos-Hanchen shift in the optical waveguide oscillation field sensor to determine the refractive index change of the test sample (Applied Physics Letters, 89 (2006) pp. 081120).

Existing technology can greatly enhance the order of magnitude of the Goos-Hanchen shift from the wavelength level to the micron and even sub-millimeter level appropriately by designing the structure. While this makes it practically usable, the enhancement of the phase variation corresponds to the enhanced absorption dip in the reflection spectrum, which is unavoidable in the existing structures. This leads to a very weak reflected intensity and a very low signal-to-noise ratio in the Goos-Hanchen shift detection, which increases the difficulty of detection and reduces the reliability of measurement.

When broadband optical pulses are propagated in optical fiber, the fiber group velocity dispersion can cause pulse broadening. Thus, dispersion compensation devices are required to compensate for the dispersion. In addition, the dispersion control device will be used for chirped-broadening of the pulse when amplifying the short light pulses. Therefore, for short pulse propagation, control, application and so on, the dispersion control device is of great significance.

Dispersion control devices that generally are used include dispersion compensation fiber (DCF), fiber Bragg grating (FBG), grating pair, Giles-Turner interferometer. The DCF has a normal dispersion at 1550 nm and can compensate for pulse broadening caused by the single-mode fiber. But since its dispersion is so small, 1 km DCF can only compensate for the dispersion of 8 km-10 km normal single mode fiber. Besides, the DCF has high transmission loss in the 1550 nm wavelength, and the high nonlinearity caused by its small mode diameter makes it not applicable for ultra-short pulses with high peak power. The FBG has large group velocity dispersion at the band gap edge and can be used for dispersion control. But due to the FBG's narrow bandwidth, long gratings are required for dispersion control; moreover the FBG is sensitive to the temperature and is not practically usable. Parallel placed grating pairs can be used as dispersive delay lines, providing anomalous group velocity dispersions for the pulses passing through, but the disadvantage is the large diffraction losses. The Giles-Turner interferometer can reflect all the pulse energy and control pulse dispersion, but its bandwidth is so narrow that the broadband dispersion control can be realized only by multi-cascaded structures.

### DETAILED DESCRIPTION OF THE INVENTION

In order to solve those problems in existing technologies mentioned above, our invention provides an optical phase device with its application method and system.

In an embodiment of the invention an optical phase device consists of a transparent dielectric substrate, a multilayer stack of dielectrics and a buffer layer which is adjacent to the external medium. The refractive indices of the transparent dielectric substrate, the multilayer stack of dielectrics and the buffer layer are all larger than that of the external medium. At the wavelength of the incident beam, the optical phase device has a phase variation in the angular range [α, β] and the critical angle of the total reflection on the interface between the buffer layer and the external medium that is adjacent to the buffer layer is γ, γ<β; where the optical phase device only consists of dielectrics materials, no metallic ones.

In an embodiment of the invention, the multilayer stack of dielectrics is formed alternately by more than two dielectric layers with different refraction indices.

In an embodiment of the invention, at the operating wavelength of the incident beam, the multilayer stack of dielectrics has a phase variation within angular range [α′, β′], where α′<α, γ<β′.

In an embodiment of the invention, the optical phase device's operating angular range is [θ1,θ2], where max(α, γ)<θ1<θ2<β, which is to say, the optical phase device works within the range where the incident angle is larger than the critical angle for total reflection.

In an embodiment of the invention, the thickness d_{buffer} of the buffer layer is greater than or equal to 0 and

$${d}_{buffer} \neq \frac{λ}{4 {π ( {n}_{buffer}^{2} - {n}_{S}^{2} {sin}^{2} θ )}^{\frac{1}{2}}} \{ π + 2 {tan}^{- 1} [ {( \frac{{n}_{buffer}}{{n}_{m}} )}^{2 p} \cdot {( \frac{{n}_{S}^{2} {sin}^{2} θ - {n}_{m}^{2}}{{n}_{buffer}^{2} - {n}_{S}^{2} {sin}^{2} θ} )}^{\frac{1}{2}} ] \}$$

where λ is the operating wavelength of the incident beam; n_{S}, n_{buffer}, nₘ are the refractive indices of the transparent substrate, the buffer layer and the external medium which is adjacent to buffer layer, respectively; p represents the polarization state of incident beam; for Transverse Magnetic (TM) polarization: p=1; for Transverse Electric (TE) polarization: p=0; θ is the operating angle of the incident beam, wherein max(α, γ)<θ<β.

In an embodiment of the invention, when this optical phase device works, its reflectivity curve decreases not more than 40 percent within an angular range of 0.1 degrees.

In an embodiment of the invention a sensing system of the optical phase device includes a light source, a polarization controller, a beam control device, a light beam coupler, an optical phase device and a detector; where an external medium comprising a test sample is adjacent to the optical phase device and an interface is formed between them; where the incident angle of the monochromatic beam projected by the light source is within the operating angular range [θ₁, θ₂]. The optical phase device consists of a transparent dielectric substrate, a multilayer stack of dielectrics and a buffer layer which is adjacent to the test sample, where the refractive indices of the transparent dielectric substrate, the multilayer stack of dielectrics and the buffer layer are all larger than the refractive index of the test sample; where the angular range of the optical phase device is [α, β], during which the device has a phase variation and the critical angle of the total reflection on the interface between the optical phase device and the test sample is γ, γ<β; wherein max (α, γ)<θ₁<θ₂<β.

In an embodiment of the invention a sensing system of the optical phase device includes a light source, a polarization controller, a beam control device, a light beam coupler, an optical phase device and a detector; where the external medium comprises a thin film under test and a bulk cladding medium; the film sample under test is adjacent to the optical phase device and forming a first interface, and the other side of the film sample is adjacent to the bulk cladding medium to form a second interface; where the refractive index of the bulk cladding medium is less than that of the film sample and the materials used in the optical phase device; where the first interface is parallel to the second interface; where the incident angle of the monochromatic beam projected by the light source is in the operating angular range [θ₁, θ₂]; where the optical phase device with the film sample attached has a phase variation within the angular range [α, β] and the critical angle for total reflection on the second interface between the film sample and the cladding medium is γ, γ<β; max (α, γ)<θ₁<θ₂<β.

In an embodiment of the invention a sensing method of the optical phase device includes the following steps:

Step 1 Fix the state of polarization of the monochrome beam; the test sample is adjacent to the optical phase device with an interface formed between them; the angular range of the incident angle of the monochromatic beam is [θ₁, θ₂]; the optical phase device has a phase variation within the angular range [α,β]; the critical angle for the total internal reflection on the first interface between the optical device and the test sample is γ, γ<β; max (α, γ)<θ₁<θ₂<β.

Step 2 Incident the monochromatic beam to the optical phase device, then the total internal reflection occurs on the interface between the optical phase device and the test sample.

Step 3 Detect the non-specular reflection parameters of the output beam.

Step 4 Based on the detected result of the non-specular parameters, the refractive index or its change of the test sample is acquired.

In an embodiment of the invention a sensing method of the optical phase device includes the following steps:

Step 10 Fix the polarization of the monochrome beam; the film sample under test is adjacent to the optical phase device and forming the first interface, and the other side of the film sample is adjacent to the external bulk cladding medium to form the second interface, and the first interface is parallel to the second one, and the refractive index of the external bulk cladding medium is less than that of the film sample under test and that of any layer in the optical phase device; the angular range of the incident angle of the monochromatic beam is [θ₁, θ₂]; the optical phase device with the film sample attached has a phase variation within the angular range [α,β]; the critical angle for the total reflection on the second interface between the film sample and the external bulk cladding medium is γ, γ<β; max (α, γ)<θ₁<θ₂<β.

Step 20 Incident the monochromatic beam to the optical phase device, and then the total reflection occurs on the second interface between the film sample under test and the external bulk cladding medium.

Step 30 Detect the non-specular reflection parameters of the output beam.

Step 40 Based on the detected result of the non-specular reflection parameters, the refractive index or thickness or their changes of the sample under test is acquired.

In an embodiment of the invention, non-specular reflection parameters mentioned in Step 3 or step 30 are the spatially lateral displacement, the longitudinal displacement, the angular deflection or the shape changes of the output beam.

In an embodiment of the invention, the incident monochromatic beam mentioned before is a quasi-parallel beam which has a central incident angle at θ and its divergent angular range is [θ−Δθ, θ+Δθ], wherein, max (α, γ)<θ−Δθ<θ+Δθ<β.

In an embodiment of the invention a sensing method of the optical phase device includes the following steps:

Step 100 The fixed polarized incident beam has a spectrum distribution in the wavelength range a [λ_{inc1}, λ_{inc2}]; the test sample is adjacent to the optical phase device and an interface between them is formed; the optical phase device has a phase variation within the angular range [α,β]; the incident angle of the beam is fixed at θ, and max (α, γ)<θ<β, where γ is the critical angle of the total reflection on the interface between the test sample and the optical phase device.

Step 200 The beam is incident to the optical phase device, and total reflected at the interface between the optical phase device and the test sample.

Step 300 Detect the spectrum or time domain reflection parameters of the output beam.

Step 400 According to the acquired spectrum or time domain reflection parameters, the refractive index or its change of the test sample is obtained.

In an embodiment of the invention a sensing method of the optical phase device includes the following steps:

Step 1000 The fixed polarized incident beam has a spectrum distribution in the wavelength range a [λ_{inc1}, λ_{inc2}]; the film sample under test is adjacent to the optical phase device and forming the first interface, and the other side of the film sample is adjacent to the external bulk cladding medium to form the second interface, and the first interface is parallel to the second one; the optical phase device with the film sample attached has a phase variation within the angular range [α, β]; the incident angle of beam is fixed at θ, max (α, γ)<θ<β, where γ is the critical angle for the total reflection on the second interface between the film sample under test and the external bulk cladding medium.

Step 2000 The beam is incident to the optical phase device, and then total reflected at the second interface between the external bulk cladding medium and the film sample under test.

Step 3000 Detect the spectrum or time domain reflection parameters of the output beam.

Step 4000 According to the acquired spectrum or time domain reflection parameters, the refractive index or the thickness or their changes of the film sample under test can be obtained.

In an embodiment of the invention a dispersion control method of an optical phase device, where the incident light beam with a certain frequency distribution is incident to the surface of the said optical device passes one or several times through the optical coupler, and the angular range of the incident beam is [θ₁, θ₂] and the optical phase device has a phase variation within the angular range [α, β], and max(α, γ)<θ₁<θ₂<β, where γ is the critical angle of the total reflection on the interface between the optical phase device and the external medium.

In an embodiment of the invention a dispersion control system of an optical phase device includes one or more optical coupling devices and the optical phase device; where the light beam with a certain frequency distribution is incident perpendicular to the surface of a first optical coupling device; where the optical phase device is adjacent to another surface of the first optical coupling device; where the light beam is incident to the surface of optical phase device and reflected for one or several times through the optical coupler and the reflector; where the angular range of the incident beam is [θ₁, θ₂] and the optical phase device has a phase variation within the angular range [α, β], and max(α, γ)<θ₁<θ₂<β.

In an embodiment of the invention, the optical device has a large phase variation with low loss, which leads to a large Goos-Hanchen shift (at the order of magnitude from hundreds of micron to millimeters). Large Goos-Hanchen shift (at large phase jump position) in previous reports is usually accompanied by the attenuation peak of the reflection spectrum. Further, the larger the phase jump, the greater the resulting loss, which results in many difficulties in measuring the Goos-Hanchen shift. These difficulties include low signal to noise ratio. By appropriate design, our invention of the optical device can generate a Goos-Hanchen shift in the range of from hundreds of microns to millimeters, which is significantly greater than existing devices. As a dispersion compensation element, it can generate large dispersion with low optical loss, which is necessary in optical dispersion control components. Furthermore different dispersion compensations can be obtained by adjusting the operating angle or attuning structure parameters.

Compared to the device using layers with high reflectivity to realize low loss, the structure of our invention is not only simple but also can realize rather high reflectivity in a large wavelength range and angular range (from the total reflection angle to 90°), which cannot be realized by other dielectrics and metal high mirrors.

The Goos-Hanchen sensing detection system and method based on this invention of the optical device structure can realize large Goos-Hanchen shift that is practically measurable with low loss. In that case the measured signal intensity can be greatly increased, which improves the signal to noise ratio, reduces the difficulty in detection, and makes it possible for high sensitivity detection under a simple experimental setup. As a result the experimental results can be several orders of magnitude higher than existing reports. During the actual measurement of the sensing system based on our invention, the optical source, optical devices, and the detection equipment in the light path can all be fixed, which makes it easy for integration, miniaturization and portability.

### BRIEF DESCRIPTION OF THE DRAWINGS

Details of the invention are described with respect to specific embodiments thereof. Additional features can be appreciated from the drawings as follows:

FIG. 1 is the schematic diagram of the optical phase device, according to an embodiment of the invention.

FIG. 2 is a graph which shows the incident angle dependence of the reflectivity of the optical phase device structure and the multilayer stack of dielectrics described in Example 1, according to an embodiment of the invention.

FIG. 3(a) is a graph which shows the incident angle dependence of the phase of the optical phase device structure described in Example 1, according to an embodiment of the invention;

FIG. 3(b) is a graph which shows the incident angle dependence of the Goos-Hanchen shift for the angle near the rising edge of the high reflectivity region of the multilayer stack of dielectrics according to an embodiment of the invention, according to an embodiment of the invention where the external medium of the optical phase device structure described in Example 1 is air.

FIG. 4(a) is a graph which shows the wavelength dependence of the phase, according to an embodiment of the invention where the incident angle is fixed at 51 degrees in the optical phase device structure described in Example 1;

FIG. 4(b) is a graph shows its wavelength dependence of its group velocity dispersion, according to an embodiment of the invention.

FIG. 5 is a graph which shows the incident angle dependences of the reflectivity and the Goos-Hanchen shift for the angle near the rising edge of the high reflectivity region in the Goos-Hanchen sensing system employing the optical phase device structure described in Example 2, according to an embodiment of the invention.

FIG. 6(a) is a graph which shows the incident angle dependence of the Goos-Hanchen shift near the rising edge, according to an embodiment of the invention where the critical angle of the total reflection is 52.87 degrees in the Goos-Hanchen sensing system employing the optical phase device described in Example 2;

FIG. 6(b) is a graph which shows the external medium refractive index dependence of the Goos-Hanchen shift, according to an embodiment of the invention where the working angle is fixed at 54.32 degrees.

FIG. 7(a) is the schematic diagram of the Goos-Hanchen sensing detection system based on the optical phase device structure described in Example 2, according to an embodiment of the invention;

FIG. 7(b) is a graph which shows the spectral phase curves with the refractive index variation of the external medium, according to an embodiment of the invention where the working angle is fixed at 53.07 degrees in the Goos-Hanchen sensing detection system;

FIG. 8(a) is a graph which shows the dependence of the phase variation Δφ of the multilayer stack of dielectrics of the incident wavelength λ, according to an embodiment of the invention where the incident angle of the dispersion compensation device described in Example 3 is fixed at 60 degrees;

FIG. 8(b) shows the relationship between group velocity dispersion and the wavelength, according to an embodiment of the invention.

FIG. 9(a) is the schematic diagram of a triangular prism coupler-based dispersion control device described in Example 3, according to an embodiment of the invention;

FIG. 9(b) is the schematic diagram of a parallelogram prism coupler-based dispersion control device, according to an embodiment of the invention;

FIG. 9(c) is the schematic diagram of the waveguide-based (e.g., optical fiber) dispersion control device, according to an embodiment of the invention.

FIG. 10(a) is the temporal intensity shape of the input pulse and the output pulse in the triangular prism coupler-based dispersion control device shown in Example 3, according to an embodiment of the invention;

FIG. 10(b) is the temporal intensity shape of the input pulse and the output pulse in the parallelogram prism coupler-based dispersion control device, according to an embodiment of the invention.

FIG. 11(a) shows the reflectivity curves, for air and water respectively, of the optical phase device shown in Example 4, according to an embodiment of the invention where the incident light is TE polarized;

FIG. 11(b) is a graph showing the variation of the Goos-Hanchen shift and its loss for air at different incident angles, according to an embodiment of the invention.

FIG. 12(a) shows the reflectivity curves, for air and water respectively, of the optical phase device in Example 4, according to an embodiment of the invention where the incident light is TM polarized;

FIG. 12(b) is a graph which shows the variation of the Goos-Hanchen shift and its loss for water at different incident angles, according to an embodiment of the invention.

FIG. 13(a) is a graph which shows the incident angle dependences of the Goos-Hanchen shift of the optical phase device with NaCl solutions of different concentrations, according to an embodiment of the invention where the incident light is TM polarized as shown in Example 4;

FIG. 13(b) is the graph which shows the NaCl solution concentration dependence of the Goos-Hanchen shift for the optical phase device, according to an embodiment of the invention where the incident angle is fixed at 53.47 degrees.

FIG. 14 is the schematic diagram of the optical phase device described in Example 5, according to an embodiment of the invention.

FIG. 15(a) is a graph showing the relationship between the phase and the incident angle, according to an embodiment of the invention where the external medium is air and the wavelength of the incident light is 980 nm for the optical phase device described in Example 5;

FIG. 15(b) shows the relationship between the phase and the wavelength of the optical phase device, according to an embodiment of the invention where the incident angle is 52 degrees and the wavelength range of the incident light is 950-1010 nm.

FIG. 16 is the Group Velocity Dispersion (GVD) curve of the optical phase device described in Example 5, according to an embodiment of the invention.

FIG. 17 is a graph showing the relationship between the phase and the incident angle for the optical phase device described in Example 6, according to an embodiment of the invention.

FIG. 18(a) is a graph showing the incident angle dependency of the Goos-Hanchen shift near the operating angle, as the refractive index of the external medium in the Goos-Hanchen sensing system employing the optical phase device described in Example 6 changes, according to an embodiment of the invention;

FIG. 18(b) is a graph showing for varying refractive indices the external medium dependency of the Goos-Hanchen shift when the operating angle is fixed at 54.895 degrees, according to an embodiment of the invention.

FIG. 19 is a graph showing for varying refractive indices the external medium dependency on the spectral phase variation of the optical phase device described in Example 6 used in spectral phase sensing detection, according to an embodiment of the invention where the operating angle is fixed at 54.92 degrees and the wavelength range of the input broadband light is 975-985 nm.

FIG. 20(a) is a graph showing the incident angle dependency on the phase variation as the thickness of the protein's adsorption thin layer changes, when the external medium is a sample solution containing a protein molecule at varying concentrations, according to an embodiment of the invention where the incident wavelength is fixed at 980 nm and the critical angle of the total reflection is 52.88 degrees as shown in Example 7;

FIG. 20(b) shows the variation of the angular dependent Goos-Hanchen shift with the increasing thickness of adsorption thin layer, during the protein adsorption process, according to an embodiment of the invention.

FIG. 21 is a graph showing the adsorption thin layer thickness dependence on the Goos-Hanchen shift, according to an embodiment of the invention where the operating angle is fixed at 65.85 degrees as in Example 7.

FIG. 22 is a graph showing the dependency of the thickness of the adsorption thin layer on the spectral phase variation of the optical phase device described in Example 7 used in spectral phase sensing detection, according to an embodiment of the invention where the operating angle is fixed at 66 degrees and the wavelength range of the input broadband light is 970-990 nm.

### SPECIFIC IMPLEMENTATION METHOD

In an embodiment of the invention of the optical phase device, the multi-layer dielectric has a certain reflectivity and large phase jump. If the multilayer dielectric can be equivalent to a reflective surface with reflectivity is r₁, the incident light of wide angular range will reflect and refract multiple times between this reflective surface and the interface where the total reflection takes place. Therefore, the reflectivity of the optical phase device Γ can be given by:

$$Γ = \frac{{r}_{1} {r}_{2} exp ( 2 i δ )}{{r}_{1} + {r}_{2} exp ( 2 i δ )}$$

where r₂ is the reflectivity of the interface where the total reflection takes place; δ is the phase change introduced by the region between the multilayer stack of dielectrics and the total reflection interface. As |r₂| equals 1 (the total reflection effect), |Γ| also equals 1 (if there is no absorption loss or scattering loss in the device). As r₁ has large phase variation related to the angle/wavelength around the operating range and δ is also affected by the angle and the wavelength of the incident light:

$$δ = \frac{2 π}{λ} {nd}_{buffer} cos {θ}_{buffer} ,$$

where λ is the wavelength, n is the refractive index of the buffer layer, d_{buffer} is the thickness of the buffer layer and θ_{buffer} is the incident angle of the incident light on the buffer layer, therefore the overall device response is affected by both the angle and the wavelength. When the incident wavelength is fixed, the angular dependent phase variation can be applied to Goos-Hanchen effect sensing. When the incident angle is fixed, different phase responses to different incident wavelengths of the incident light can be used for dispersion control.

### Example 1

FIG. 1 shows the schematic diagram of an optical phase device provided by our invention.

In this example, the polarization of the input light is TM polarization, and the wavelength is set as 980 nm. The material of the transparent dielectric substrate 101 is ZF10 glass with its refractive index of 1.668. The material of each layer in the multilayer stack of dielectrics 102 is supposed to be ideal transparent dielectric, where there is neither absorption loss, nor interface dispersion loss between each layer. The material of the high refractive index dielectric thin layer 106 is titanium dioxide with its refractive index of 2.3, and the material of the low refractive index dielectric thin layer 107 is silica dioxide with its refractive index of 1.434; the material of the buffer layer 103 is titanium dioxide as well; the external medium 104 is air. In this example the critical angle of the total reflection on the reflection surface 105 is 36.83 degrees, which is the incident angle in the transparent dielectric substrate. In the following all angles in examples are the incident angles in the transparent dielectric substrate. The thickness d_{buffer} of the buffer layer is greater than or equal 0, and it is given by:

$${d}_{buffer} \neq \frac{λ}{4 {π ( {n}_{buffer}^{2} - {n}_{S}^{2} {sin}^{2} θ )}^{\frac{1}{2}}} \{ π + 2 {tan}^{- 1} [ {( \frac{{n}_{buffer}}{{n}_{m}} )}^{2 p} \cdot {( \frac{{n}_{S}^{2} {sin}^{2} θ - {n}_{m}^{2}}{{n}_{buffer}^{2} - {n}_{S}^{2} {sin}^{2} θ} )}^{\frac{1}{2}} ] \}$$

where λ is the wavelength of the incident beam; n_{S}, n_{buffer}, nₘ are the refractive indices of the transparent dielectric substrate, the buffer layer and the external medium which is adjacent to the buffer layer, respectively. p represents the polarization state of the incident light beam; for TM polarization: p=1; for TE polarization: p=0. θ is the operating angle of the input beam, and max(α, γ)<θ<β.

In this example, the thin layer with high refractive index dielectric 106 and the thin layer with low refractive index dielectric 107 are arranged alternatively as one period, and repeated for several times. By designing the thickness of each layer in one period, the high reflectivity range of the multilayer stack of dielectrics can be changed. In this example, for each period, the thickness of the thin layer with high refractive index dielectric 106 is 156.5 nm and that of the thin layer with low refractive index dielectric 107 is 382 nm and the multilayer stack of dielectrics 102 is made of 10 periods. The thickness of the buffer layer 103 is 20 nm.

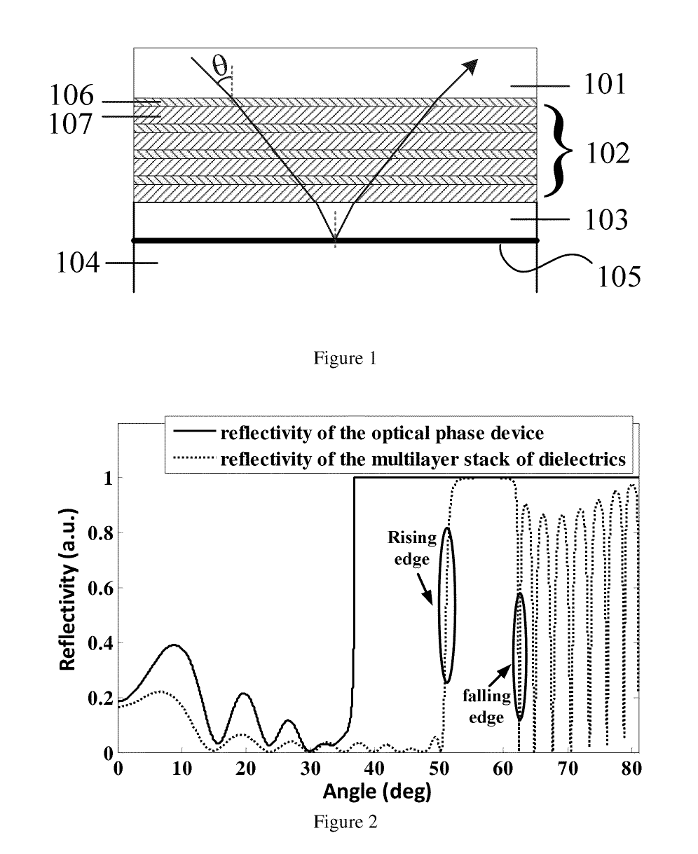

The theoretical reflectivity curve of the optical phase device structure formed by ideal transparent dielectric layer can be calculated by the Fresnel equations, as shown in solid lines in FIG. 2. When the refractive indices of the buffer layer 103 and the external media 104 are set the same as that of the transparent dielectric substrate 101, the angular reflectivity of the multilayer stack of dielectrics 102 without the total reflection can also be calculated by Fresnel equations, as shown in dashed lines in FIG. 2, whose high reflectivity range is 50-62 degrees. In this example, large phase jump occurs near the rising and falling edge of the high reflectivity range of the multilayer stack of dielectrics 102 respectively, and the angular position of the phase jump is greater than the total reflection angle of the optical phase device.

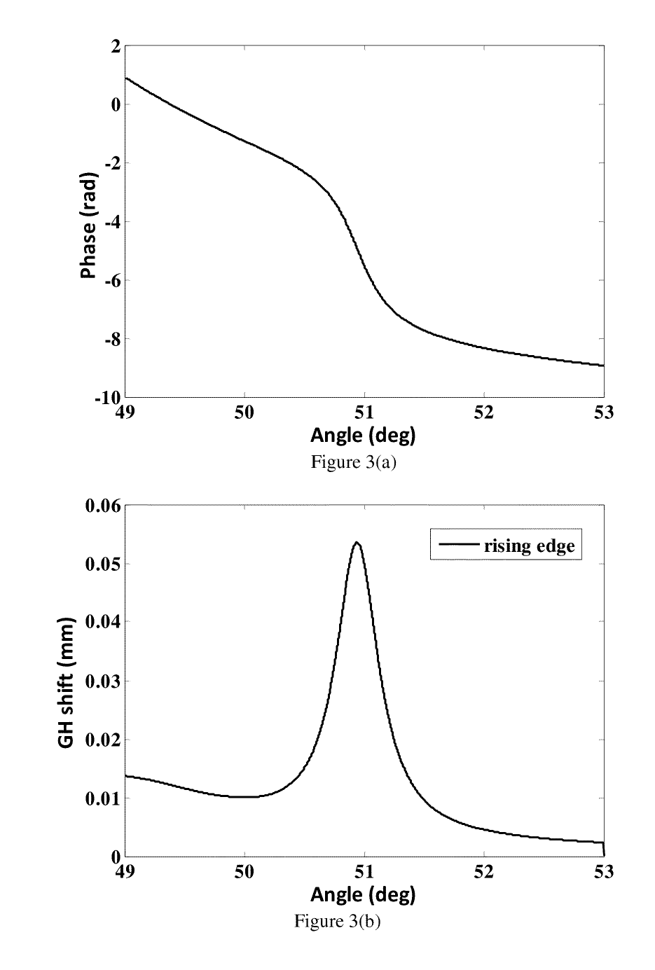

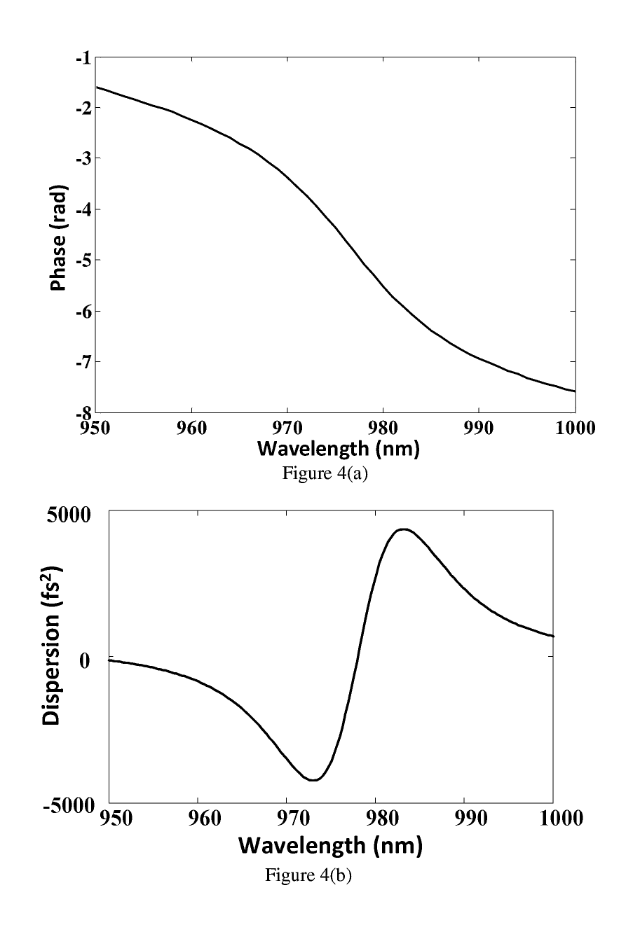

For the fixed wavelength, taking the rising edge for example, for the multilayer stack of dielectrics, there is a large phase change in the incident angular range of 49-51 degrees and the maximum phase change is at 50.25 degrees; while for the optical phase device, a large phase change takes place during the incident angular range of 50-52 degrees with its maximum phase change at 50.95 degrees, as shown in the angle-phase curve in FIG. 3(a). Therefore a large Goos-Hanchen shift (up to the order of magnitude of hundreds microns) can be obtained as shown in FIG. 3(b). At the fixed angle of 51 degrees, a large phase variation for the incident wavelength range of 950 nm-1000 nm for the optical phase device is shown in the wavelength dependent phase curve in FIG. 4(a) and its wavelength dependent group velocity dispersion curve is shown in FIG. 4(b).

### Example 2

In this example, the polarization of the input light is TM polarization, and the wavelength is set as 980 nm. For the optical device structure shown in FIG. 1, the material of the transparent dielectric substrate 101 is ZF10 glass whose refractive index is 1.668; for the multilayer stack of dielectrics, the high refractive index dielectric thin layer 106 and the low refractive index dielectric thin layer 107 are arranged alternatively for 10 periods, wherein the material of the high refractive index dielectric thin layer 106 is titanium dioxide with refractive index of 2.3 and thickness as 196.7 nm; the material of the low refractive index dielectric thin layer 107 is silica with refractive index of 1.434 and thickness as 365.3 nm; the material of the buffer layer 103 is titanium dioxide with refractive index of 2.3 and thickness as 20 nm.

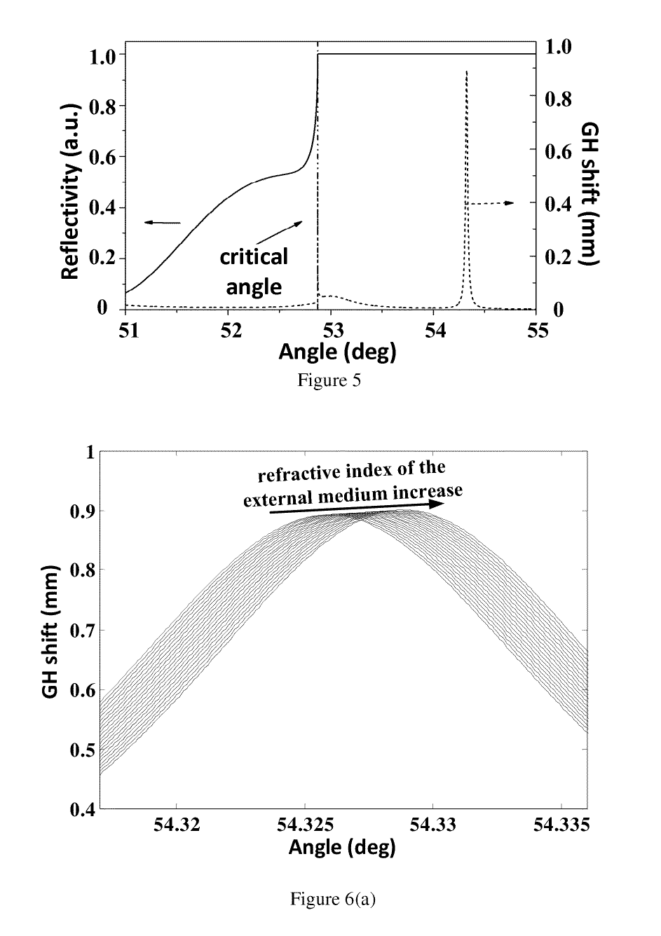

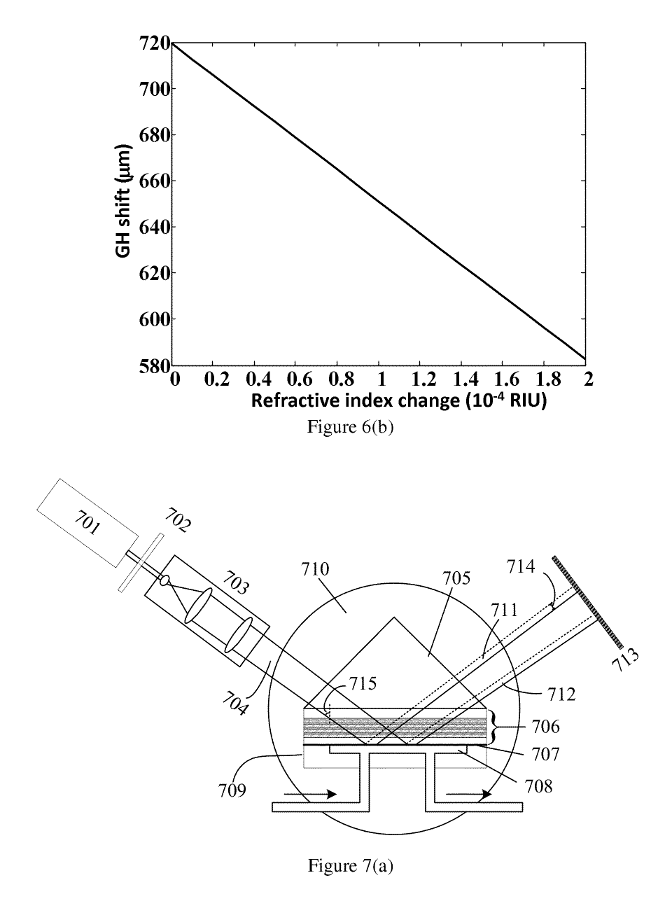

The optical phase device described above is used for Goos-Hanchen sensing detection, and the test sample is NaCl aqueous solutions of different concentrations. Its initial refractive index is 1.33 which makes the critical angle of the total reflection 52.87 degrees. The reflectivity of the optical phase device and the Goos-Hanchen shift near the rising edge is shown in FIG. 5. With the refractive index changes in the external medium (the step of the refractive index change is 0.00001), the curve of the Goos-Hanchen shift near the rising edge is shown in FIG. 6(a). In this example of sensing detection, the operating angle is fixed at 54.32 degrees. The relationship between the Goos-Hanchen shift and the refractive index of the external medium at this fixed angle is shown in FIG. 6(b).

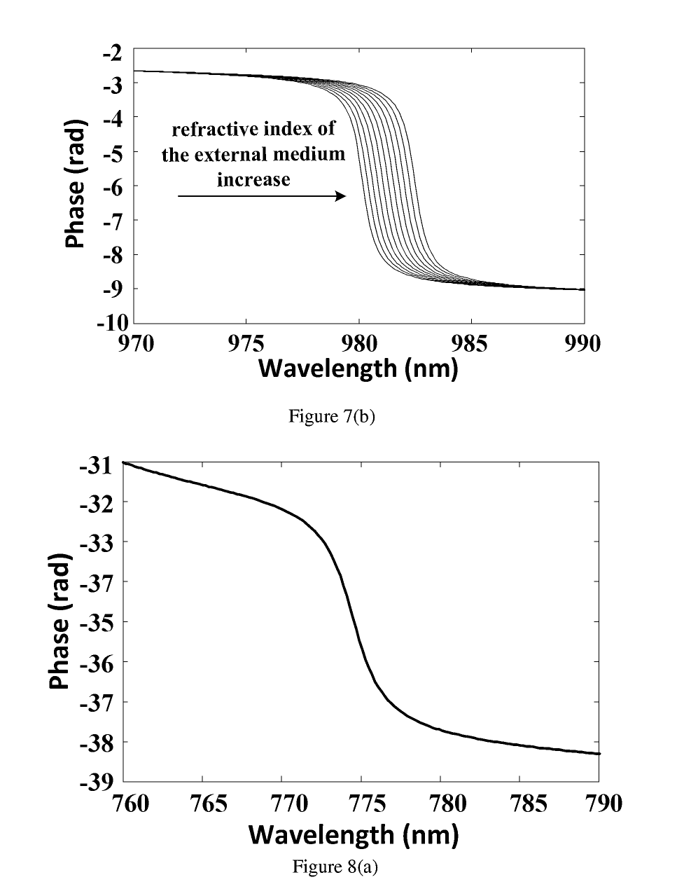

FIG. 7(a) presents a Goos-Hanchen sensing detection system and its operating principle according to an embodiment of the invention. The system includes the light source 701, a polarization controller 702, and a beam control device 703. The output of the light source 701 propagates through the polarization control device 702 and the beam control device 703, and then passes through a quasi-parallel monochromatic beam with TM polarization 704 is obtained; this quasi-parallel monochromatic light beam 704 propagates through the optical coupling component 705 and then incident on the optical phase device 706. The total reflection takes place at the interface 707 between 706 and the external medium 708 comprising the sample under test, then the reflected beam 712 is received by the detection device 713 and the position of the beam is recorded. Comparison with the reference position of the reflected beam 711 obtained without the Goos-Hanchen effect, can be used to determine the value of the Goos-Hanchen shift 714, where the external medium 708 comprising the sample under test can be introduced through the sample pool and the microfluidic system 709.

The optical coupling component 705, the optical phase device 706, and the sample pool and microfluidic system 709 described in this embodiment of the invention are fixed on the rotation stage 710. The incident angle of 704 is changed by rotating the rotation stage 710. When the incident angle is adjusted to the operating angle 715, detect at this angle with the whole setup fixed.

A light source that generates light beam at 980 nm wavelength with good monochromatic characteristics is employed as light source 701 described in this embodiment of the invention.

In an embodiment of the invention, a Glan prism or a polarizer can be employed as the polarization control device 702, which allows the TM or TE polarization.

In this embodiment, the beam control device 703 consists of a lens group, which completes beam expansion, collimation and other functions, turning the output beam 704 into a quasi-collimated beam of which the divergence angle is controlled smaller than 0.01 degrees.

In this embodiment, the operating angle is chosen to ensure that the total reflection takes place on the interface 707, thus the operating angle should be larger than the critical angle decided by the external medium 708. In addition, the optimized operating angle is selected by considering where the Goos-Hanchen shift is large after the critical angle. According to the angular dependent Goos-Hanchen shift curve as showed in FIG. 5, which is calculated based on the parameters of each layer in the optical phase device 706, where the operating angle is fixed at 54.32 degrees. It was experimentally found that by rotating the rotation stage 710 and measuring from different angles, the angular dependent Goos-Hanchen shift curve can be acquired, and then the operating angle can be found.

In this embodiment, the reference reflected beam 711 can be obtained by either changing the polarization state of the polarization control device 702 to TE polarization, in which case the Goos-Hanchen effect doesn't occur or the shift introduced is negligible at this fixed incident angle, or by changing the external medium 708 to make the Goos-Hanchen shift not occur or the shift become negligible.

The detector 713 can be used to detect one or more of the non-specular parameters of the reflected beam 714, e.g., to record the position information of the reflected beam in this embodiment. A Charge Coupled Device (CCD) or position sensitive detector (PSD) can be used as the detector.

The external medium 708 in the sample pool and the microfluidic system 709 in this embodiment is NaCl solution with different concentrations, and the refractive index difference between two adjacent samples is 1×10⁻⁵ Refractive Index Units (RIU).

At the operating angle chosen in this embodiment, for the sample under test with its initial refractive index of 1.33, the sensitivity of the sensing system is 1.4×10⁻⁶ RIU/μm, which can be improved by further optimization of the optical phase device structure.

In an embodiment of the invention, a detection method of the Goos-Hanchen sensing system is as follows:

Firstly, by rotating the rotation stage 710, the incident angle of the beam is fixed at the operating angle which is larger than the critical angle of the total reflection and is designed to introduce a large Goos-Hanchen shift for the TM polarized monochromatic quasi-parallel beam and for the external medium 708;

Then the monochromatic light output from the light source 701 passes through the polarization control device and the beam control device, and the TE polarized quasi-parallel monochromatic referencing beam is obtained;

The TE polarized quasi-parallel monochromatic reference beam propagates through the optical coupling component described above (in this embodiment it is a high refractive index prism) and is incident to the optical phase device, then total reflected on the surface 707;

Detector described in this embodiment is used to detect the referencing reflected beam 711 and record its position;

Adjust the polarization control device to make the output of the light source 701 a TM polarized quasi-parallel monochromatic beam after passing through the polarization control device and the beam control device;

The TM polarized quasi-parallel monochromatic beam passes through the optical coupling component and is incident on the interface between the optical phase device and the external medium under test, then total reflected on the reflecting surface 707;

Use the detector described to detect the reflected beam 712, record the position, and subtract that of the referencing reflected beam, to obtain the Goos-Hanchen shift which is sensitive to the refractive index change of the external medium under test;

According to the acquired value of the Goos-Hanchen shift and the relationship between the Goos-Hanchen shift and the refractive index of the external medium at such an operating angle (shown in FIG. 6(b)), the refractive index change of the external medium can be obtained.

In an embodiment of the invention, the optical phase device can also be applied to phase sensing detections in frequency domains. The samples are NaCl solutions of different concentrations with initial refractive index of 1.33, and the operating angle is 53.07 degrees. The frequency dependent phase variation curves with different refractive indices of the external medium at this angle are shown in FIG. 7(b), wherein the step of the refractive index change of the sample under test is 5×10⁻⁵ RIU. The optical phase device described above can be applied in the spectral phase detection, and the detection system and method are similar to technical solutions described in the Chinese patent “A surface plasmon resonance phase measurement method and measurement system” with application No. 2008100569534 which is herein incorporated by reference in its entirety.

In an embodiment of the invention, a method of spectral phase detection based on the optical phase device is as follows:

Firstly, a broadband beam output from a coherent or incoherent broadband light source such as white light sources and mode-locked lasers propagates through the first polarization control device where the polarization state is adjusted to 45 degrees linear polarization from TE polarization, and then through the delay element which can be bi-refringent crystals such as yttrium ortho-vanadate or calcite, and then through the second polarization control device whose polarization state is the same as or perpendicular to the polarization state of the first polarization control device (i.e. 45° from TE polarization), and then through the optical phase device where the sample pool is filled with the sample under test. Then the beam is detected and received by the optical spectrum analytical devices such as spectrometer or a monochromator, and the spectral intensity iₚₕₐₛₑ(λ) can be obtained. By measuring the spectral intensity and analyzing the variation of the interference fringes, the corresponding spectral phase response can be determined. According to the shift of the spectral phase curve, information such as the refractive index change of the sample under test can be obtained accurately.

### Example 3

The schematic diagram of the optical phase device used in this embodiment is as shown in FIG. 1. The material of the transparent dielectric substrate 101 is ZF1 glass. The multilayer stack of dielectrics 102 consists of 14 periods, and for each period, the high refractive index dielectric thin layer 106 is a layer of tantalum oxide with thickness of 264 nm and the low refractive index dielectric thin layer 107 is a 184 nm thick layer of silica. The buffer layer 103 is a layer of tantalum oxide of 21 nm thick, and the external medium 104 is air. The working range of the wavelength is 760-790 nm and the refractive index of each layer described above can be calculated through Sellmeier equation. By designing the thickness of each layer, high reflectivity region of this optical phase device can be designed.

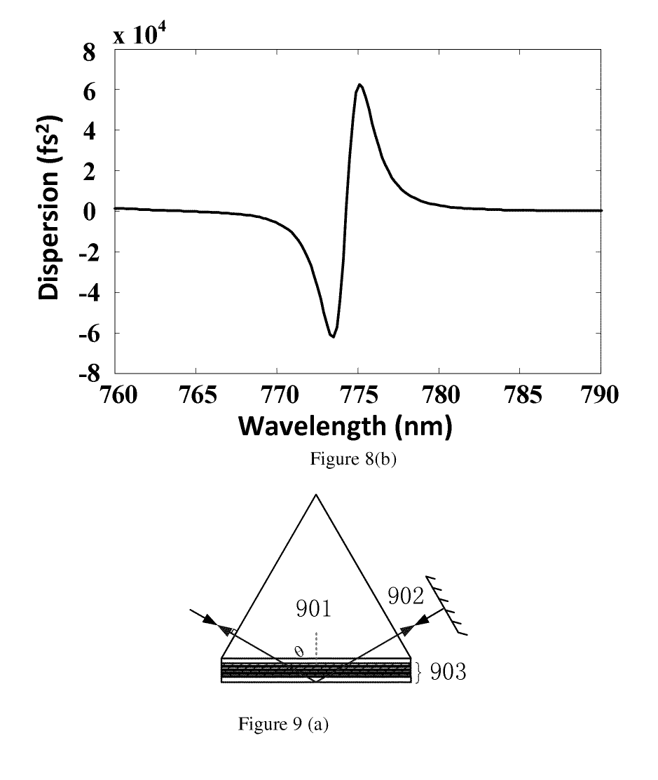

When the incident angle is 60 degrees, the curve of the phase variation Δφ of multi-layer dielectric 102 against the wavelength λ, of the incident beam for TM polarization can be calculated by Fresnel equation. As shown in FIG. 8(a), there is a large phase variation Δφ at 775 nm. The group velocity dispersion β₂L of the device can be calculated based on Δφ, wherein L is the optical path at this incident angle of the optical device, and β₂ is the group velocity dispersion coefficient given by:

$${β}_{2} = \frac{{d}^{2} β}{d {ω}^{2}} ;$$

where, β is the propagation constant, and β=Δφ/L. As can be seen from FIG. 8(b), when the wavelength is 775 nm, the group velocity dispersion reaches its maximum which is normal dispersion. When the wavelength changes within the range of 760-790 nm, the incident angle) (60°) is greater than the critical angle of the total reflection that takes place at every wavelength in this case.

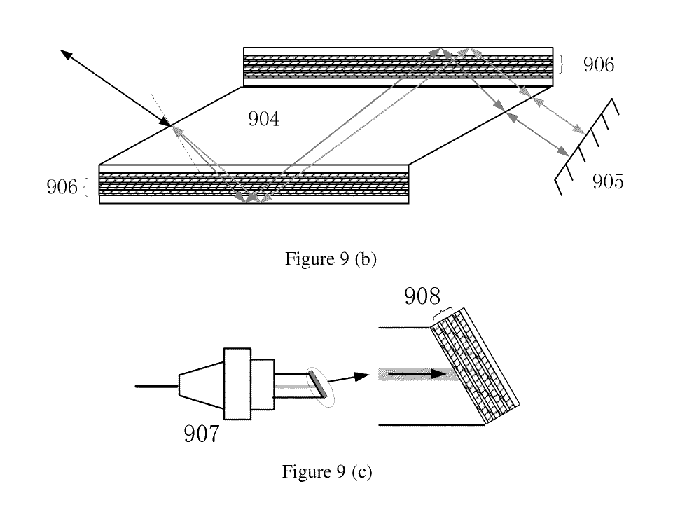

In this embodiment, the system configuration of the dispersion control method based on the optical device described above can use coupling prism, as shown in FIG. 9(a) and FIG. 9(b), or waveguide structures like optical fiber, as shown in FIG. 9(c).

As shown in FIG. 9(a), in the triangular prism coupler-based structure, there is a multilayer stack of dielectrics 903. The material of the equilateral triangle coupling prism 901 is ZF1 glass. The incident beam is perpendicularly incident on the left surface of the prism and couples into the optical device described above at 60 degrees as incident angle, then the reflected beam perpendicularly exits from the right surface of the prism and is perpendicularly incident on the reflecting mirror 902, and then returns along the original optical path back. In this embodiment of the invention, the incident beam should be perpendicularly or approximately perpendicularly incident to the left surface of the prism in order to prevent the output beam from spreading out spatially.

Because the dispersion of the whole optical component described above is much larger than the material dispersion of the prism, the material dispersion of the prism is not taken into consideration. The central wavelength of the incident pulse is 775 nm, and the full width at half maximum (FWHM) is 200 fs with the pulse shape as hyperbolic secant. Its field function is supposed to be A (0, t), then the final output pulse is given by:

$$A ( z , t ) = \frac{1}{2 π} {\int }_{- ∞}^{+ ∞} \tilde{A} ( 0 , ω ) exp ( i2Δφ ) exp ( - iω t ) d ω$$

with

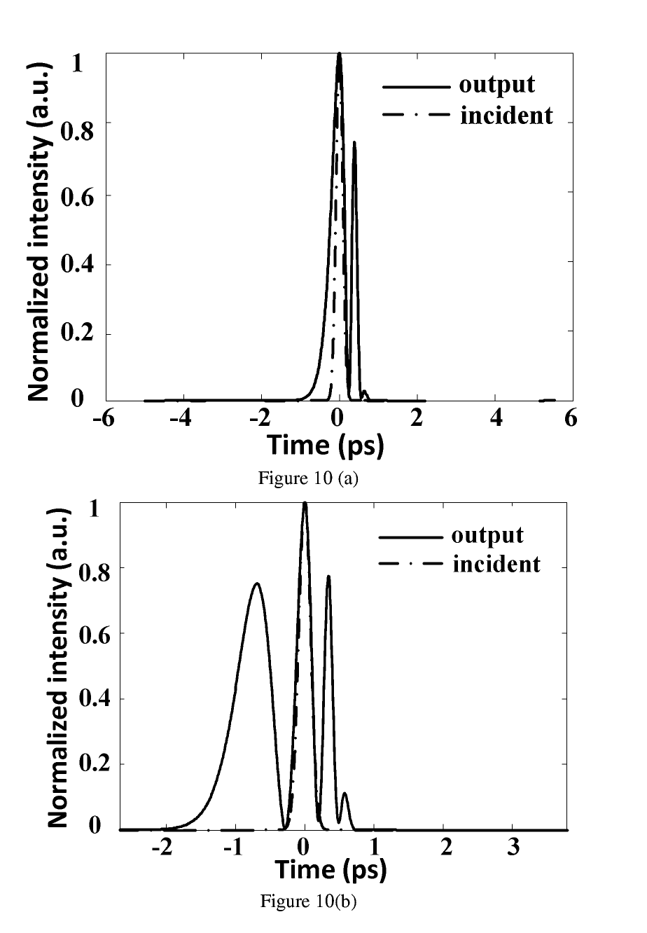

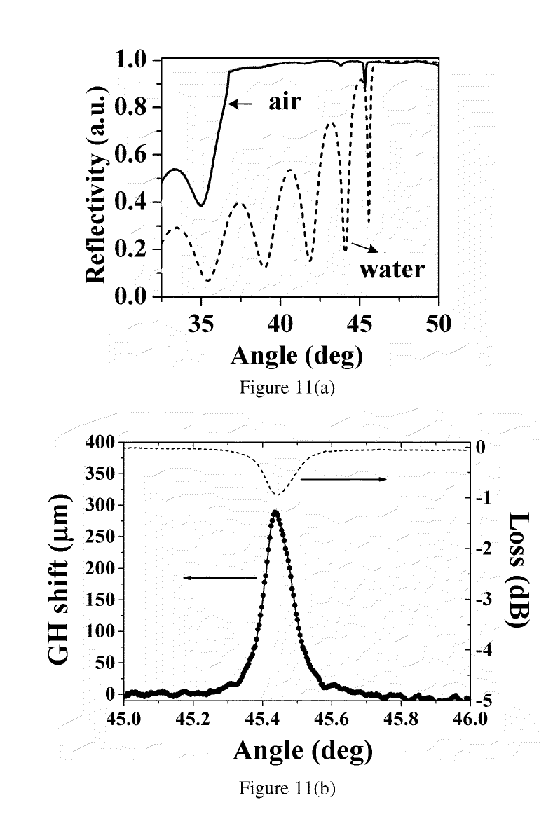

Ã(0,ω)=∫_{-∞}^{+∞}A(0,T)exp(−iωT)dT

wherein the phase variation is 2Δφ for only taking the phase change introduced by passing through the optical phase device twice into consideration, without considering the free-space propagation and the prism's influence. The temporal intensities of the incident pulse and the output pulse are shown in FIG. 10(a). Because of the large third-order dispersion, the output pulse shape changes from a single pulse to a main pulse plus a secondary pulse; in the meantime the FWHM of the main pulse is 380 fs.

As shown in FIG. 9(b), the parallelogram-coupling-prism-based dispersion control system configuration has a multilayer stack of dielectrics 906, wherein the material of the coupling prism 904 is ZF1 glass. The beam is incident on the left surface of the prism and couples into the optical device described above at 60 degrees as incident angle, and then exits from the right side of the prism after two reflections, and then perpendicular incident on the reflecting mirror 905, and after that goes back along the original optical path. The temporal intensities of the incident pulse and the output pulse are shown in FIG. 10(b). Because of the large third order dispersion, the output pulse shape changes from a single pulse to three pulses. For the parallelogram prism coupling, it's not necessary to keep incident beam perpendicularly or approximately perpendicularly incident to the left surface of the prism in order to prevent the output beam from spreading out spatially.

The dispersion control method based on this optical device can also be realized by non-prism coupling, including fiber or other waveguides based coupling. In the fiber-based dispersion control system as shown in FIG. 9(c), the end face of the optic fiber connector 907 is an inclined plane with a certain angle to the radial direction of the optical fiber. The fiber optical connector is not only the substrate of the multilayer stack of dielectrics, but also the coupling device which ensures that the incident light, by going through the optical fiber, is coupled into the multilayer stack of dielectrics 908 at certain angle, which realizes the dispersion control.

### Example 4

In the device structure shown in FIG. 1, the incident wavelength is chosen as 980 nm. The material of the transparent dielectric substrate 101 is ZF10 glass, whose refractive index is 1.668. The multilayer stack of dielectrics 102 is composed of 10 periods, in which the high refractive index thin layer 106 is a layer of titanium dioxide whose refractive index is 2.3, and thickness is 163 nm, the low refractive index thin layer 107 is a layer of silica whose refractive index is 1.434 and thickness is 391 nm. The buffer layer 103 is a 23 nm thick titanium dioxide layer, whose refractive index is 2.3. FIG. 7(a) shows the schematic diagram of the experimental setup for Goos-Hanchen shift measurement and sensing detection. In this embodiment, the polarization control device 702 is realized by a Glan prism and a half-wave plate, and the beam control device 703 is realized by a group of lenses and a pinhole. The waist of the output quasi-paralleled monochromatic beam is 750 microns.

FIG. 11(a) shows the reflectance measured in experiment by using a photodiode and a lock-in amplifier for the external medium as air and water respectively, when the polarization state of the input beam is TE polarization. For TE polarization, the rising edge of the band gap of this structure is 45.4 degrees; when the external medium is air, the critical angle for total reflection is 36.8 degrees, which is smaller than the rising edge of the band gap. In this embodiment of the invention, the input light should be totally reflected near the rising edge. But the transparent dielectric (e.g., titanium dioxide) actually used is not ideal. Usually there exists very weak material loss and sometimes weak scattering losses introduced during the devices' fabrication process (imaginary part of the complex refractive index is approximately the order of 10⁻⁴). So there is a small loss (approximately 1 dB) near this position, which as a result does not achieve 100% transmission. When the external medium is air, the Goos-Hanchen shift and the corresponding loss near the rising edge of the band gap that is measured by using the CCD is shown in FIG. 11(b).

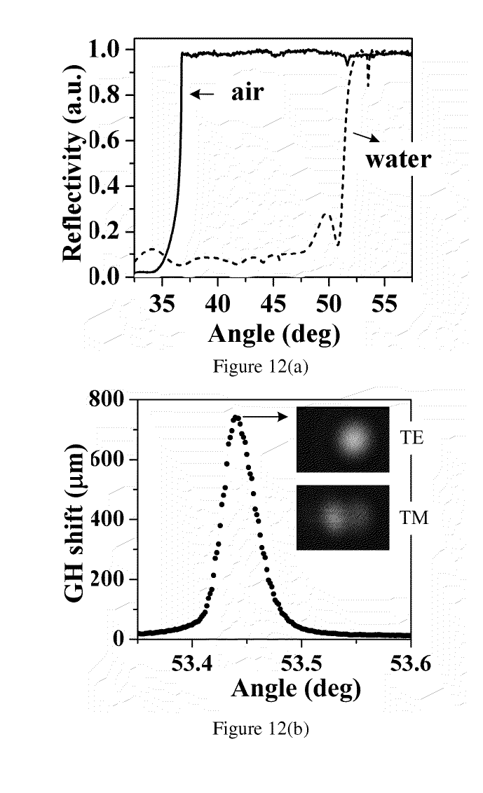

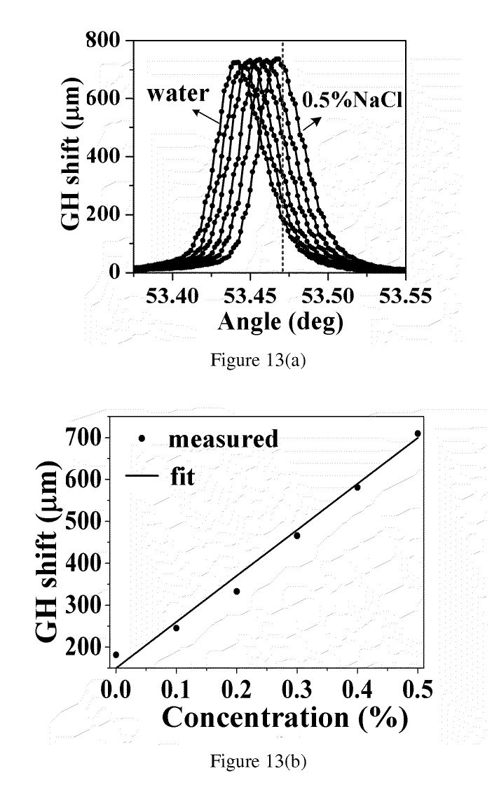

FIG. 12(a) shows the reflectance measured in experiment for the external medium as air and water respectively, when the polarization state of the input beam is TM polarization. For TM polarization, the rising edge of the band gap of this structure (52.2 degrees) is very close to the critical angle of total reflection for water (52.9 degrees). During the operating range which is from 53.35 degrees to 53.6 degrees, the input beam is total reflected, and the Goos-Hanchen shift can reach 740 microns, as shown in FIG. 12(b). The small drawing inserted in FIG. 12(b) shows the image of the reflected beam spot obtained with the CCD, where the TE polarization is as reference. Use this device in Goos-Hanchen sensing detection, and the samples are NaCl aqueous solutions of different concentrations, from pure water to 0.5% NaCl solution, with step of 0.1% (the corresponding refractive index difference is 1.76×10⁻⁴ RIU). The angular dependent Goos-Hanchen shift curves for different samples are shown in FIG. 13(a). When the incident angle is fixed at 53.47 degrees, the relationship between the Goos-Hanchen shift and the concentration of the sample is shown in FIG. 13(b).

### Example 5

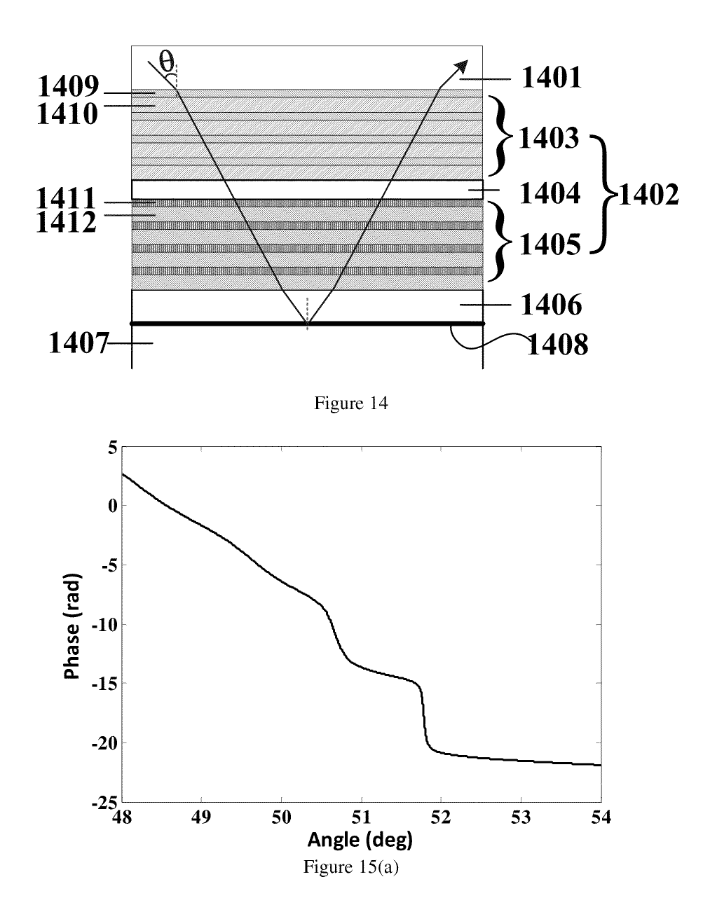

The schematic diagram of the optical phase device used in this embodiment of the invention is shown in FIG. 14. The material of the transparent dielectric substrate 1401 is ZF10 glass; the multilayer stack of dielectrics 1402 consists of dielectric layer 1403, 1404 and 1405, which are all made up of different alternating dielectric layers. Dielectric layer 1403 consists of 10 periods, and one period is made up of a thin layer of high refractive index dielectric 1409 and a thin layer of low refractive index dielectric 1410. Dielectric layer 1404 in this embodiment is made up of a thin layer of single dielectric material. Dielectric layer 1405 consists of 14 periods, and one period is made up of a thin layer of high refractive index dielectric 1411 and a thin layer of low refractive index dielectric 1412. In dielectric layer 1403, the materials of the high refractive index dielectric thin layer 1409 and the low refractive index dielectric thin layer 1410 are titanium dioxide and silica respectively, and the thicknesses are 155.5 nm and 382 nm, respectively. The material of dielectric layer 1404 is titanium dioxide, and the thickness is 20 nm. In dielectric layer 1405, the materials of the high refractive index dielectric thin layer 1411 and the low refractive index dielectric thin layer 1412 are tantalum pentoxide and silica, and the thicknesses are 268 nm and 189 nm respectively. The material of the buffer layer 1406 is tantalum pentoxide and the thickness is 21 nm.

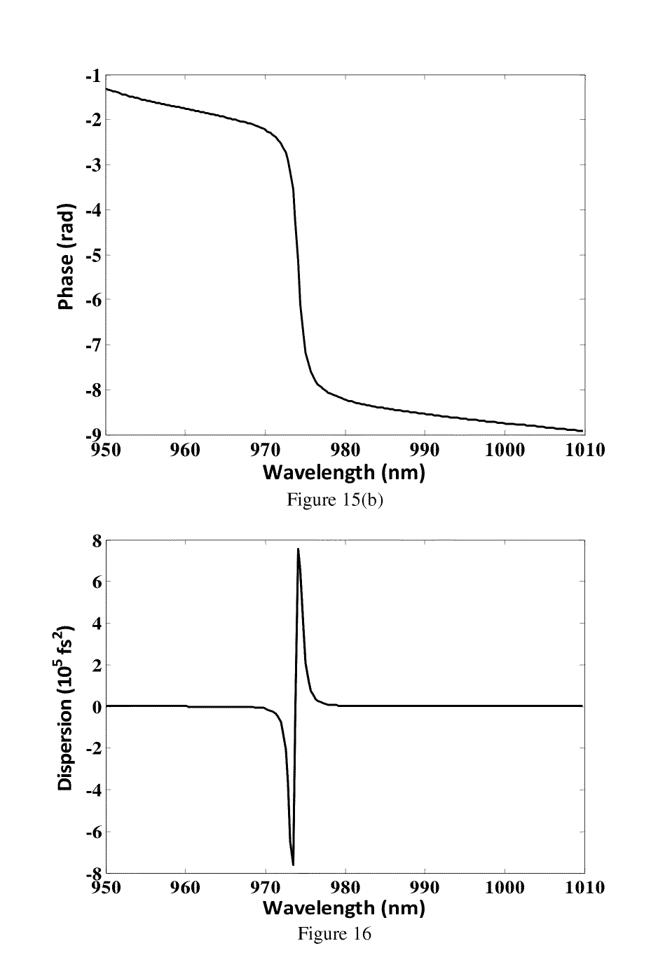

The input beam is TM polarization and the wavelength is 980 nm. The external medium 1406 is air. The refractive index for each layer in the multilayer stack of dielectrics 1402 is as following: tantalum pentoxide of 2.0001, silica of 1.434, and titanium dioxide of 2.3. For this structure, a large phase variation occurs in the angular range 51.5-52.5 degrees, as shown in FIG. 15(a). When the incident angle is fixed at 52 degrees, within the wavelength range 950-1010 nm, the critical angle for total reflection of this optical device is smaller than the incident angle. In this embodiment of the invention, using this wavelength range, the input light should be total reflected. The dispersion relationship of the materials can be calculated by dispersion formulas like the Sellmeier equation, so the refractive index of each layer of each wavelength can be obtained for accurate calculation. The spectral phase variation of this device is shown in FIG. 15(b). Based on this phase variation, the group velocity dispersion β₂L can be acquired, as shown is FIG. 16.

### Example 6

The schematic diagram of the optical phase device of this embodiment is as shown in FIG. 1. The input beam is TM polarization, and the wavelength is 980 nm, which can be realized by using a laser or a broadband light source with a narrow band pass filter whose central wavelength is 980 nm. The material of the transparent dielectric substrate 101 is ZF10 glass and its refractive index is 1.668089. In this embodiment, the high refractive index dielectric thin layer 106 and the low refractive index dielectric thin layer 107 are arranged alternatively in one unit, and there are 10 units in the multilayer stack of dielectrics 102. The material of the low refractive index dielectric thin layer 107 is silica with its refractive index of 1.434, and the thickness of 107 is fixed in each unit, as 370 nm. The material of the high refractive index dielectric thin layer 106 is titanium dioxide with its refractive index of 2.3. The thickness of 106 in each unit varies randomly with Gaussian distribution, with its mathematical expectation of 200 nm and standard deviation of 10 nm. In this embodiment, for the units from top to bottom begin with the transparent dielectric substrate, the thicknesses of 107 are 186.7 nm, 176.7 nm, 185.5 nm, 203.3 nm, 203.9 nm, 204.5 nm, 198.7 nm, 201.8 nm, 195.2 nm, 208.6 nm respectively. The material of the buffer layer 103 is titanium dioxide with its refractive index of 2.3, and the thickness of 103 is 30 nm.

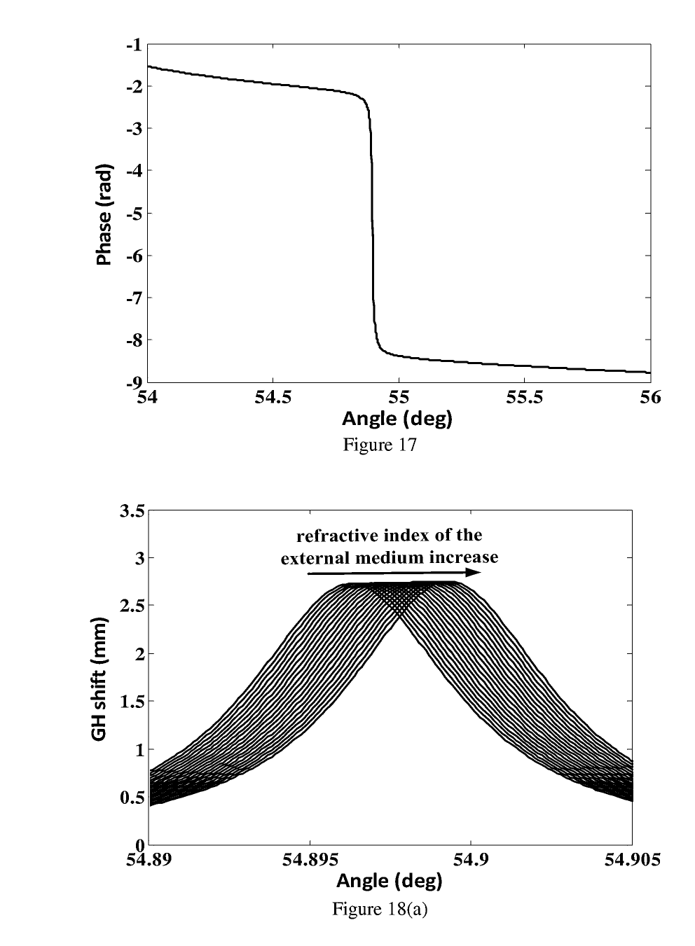

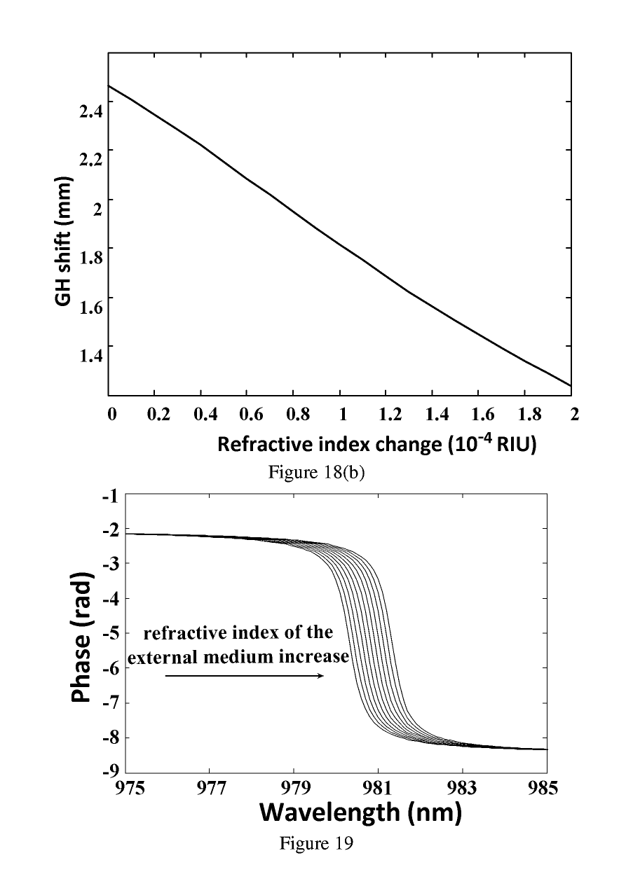

Applying this optical phase device into Goos-Hanchen sensing detection, the test samples are NaCl solutions of different concentrations with its initial refractive index of 1.33, and the critical angle for total reflection is 52.87 degrees. The angular range for the large phase variation is from 54 degrees to 56 degrees, as shown in FIG. 17. The angular dependent Goos-Hanchen shift curves for different samples (refractive index difference is 1×10⁻⁵ RIU) near the operating angle 54.895 degrees are shown in FIG. 18(a). When the incident angle is fixed at 54.895 degrees, the relationship between the Goos-Hanchen shift and the refractive index of the external medium is shown in FIG. 18(b). For test sample with its initial refractive index of 1.33, at this operating angle, the sensing sensitivity is 1.6×10⁻⁷ RIU/μm.

Applying the optical phase device into spectral phase sensing detection, the test samples are NaCl solutions of different concentrations with initial refractive index of 1.33, and the operating angle is set to 54.92 degrees. Suppose that the wavelength range of the input light is 975-985 nm, the relationship between the spectral phase variation and the refractive index of the external medium is shown in FIG. 19, wherein the refractive index change of the test sample is 1×10⁻⁴ RIU.

### Example 7

The schematic diagram of the optical phase device of this embodiment is as shown in FIG. 1. The input beam is TM polarization, and the wavelength is 980 nm. The material of the transparent dielectric substrate 101 is ZF10 glass and its refractive index is 1.668. In this embodiment, the multilayer stack of dielectrics 102 consists of seven layers. From top to bottom, there are titanium dioxide, silica, tantalum pentoxide, silica, titanium dioxide, silica, and tantalum pentoxide with the refractive index of 2.3, 1.434, 2, 1.434, 2.3, 1.434, 2, and thickness of 195, 365, 255, 380, 185, 400, 200 nm respectively. The thickness of the buffer layer 103 is 0 (zero).

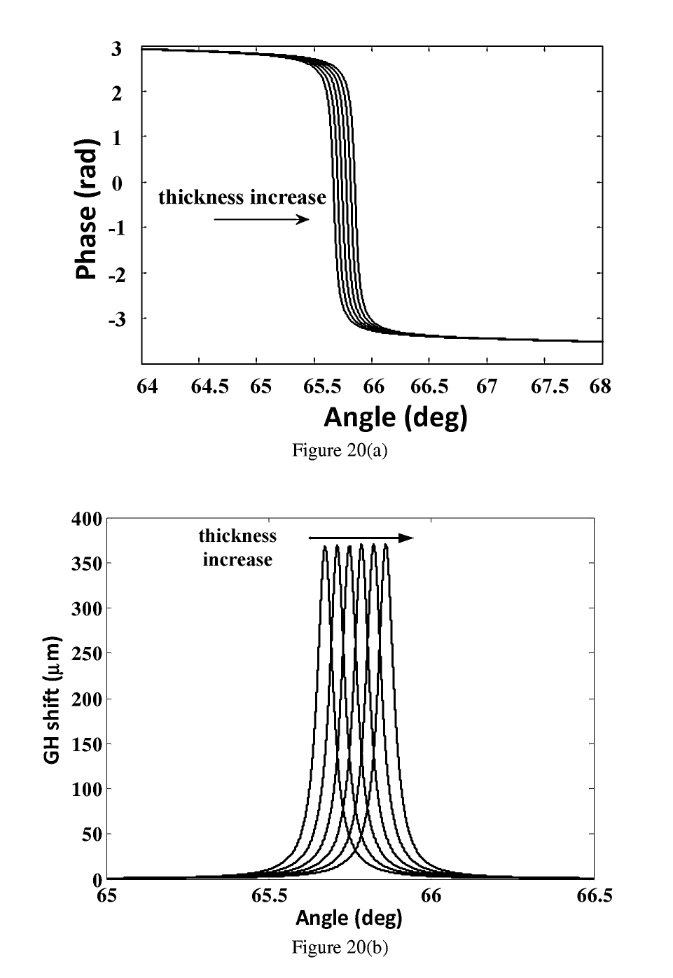

For this optical phase device using the aqueous solution as its external medium, there exists a large phase variation in the angular range of 64-68 degrees. When the external medium is test sample solution of different concentrations, the phase change curve varies with the refractive index of the test sample solution. When the external medium is sample solution which contains certain concentration of protein molecule, under certain conditions, the protein molecule can form an adsorptive thin layer on the surface of the optical phase device, wherein in this case the external medium comprises a thin layer that serves as the test sample and a bulk cladding medium. And the phase change curve varies with the thickness of the adsorptive thin layer, as shown in FIG. 20(a).

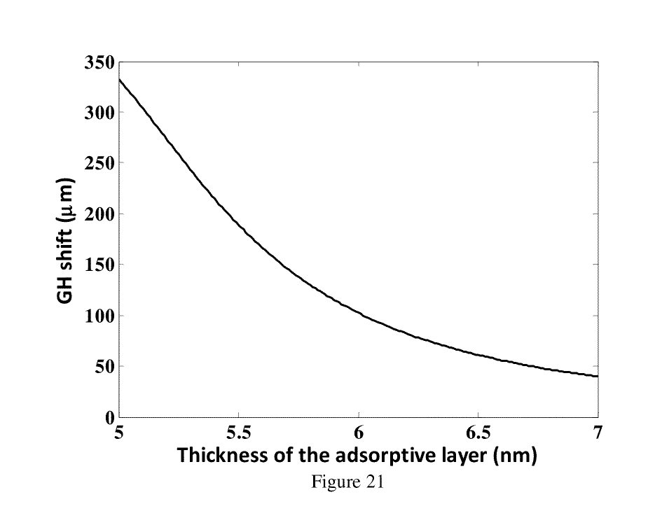

Applying the optical phase device into Goos-Hanchen sensing detection, the wavelength of the incident light is 980 nm. The external medium is phosphate (PBS) solution containing certain concentration of protein molecular. The refractive index of the protein adsorptive thin layer is 1.5 and the refractive index of the PBS solution that serves as the bulk cladding medium is 1.3301. The critical angle for total reflection at the interface between the adsorptive thin layer under test and the cladding medium is 52.88 degrees. During the protein molecule's adsorption process, with the increase of the thickness of the adsorptive thin layer (from 0 nm to 5 nm with a step size of 1 nm), the Goos-Hanchen shift near the operating angle changes as shown in FIG. 20(b). The thickness-angle sensing sensitivity is 26.3 nm/degree. When the operating angle is fixed at 65.85 degree, for the adsorptive thin layer with its initial thickness of 5 nm, the relationship between the Goos-Hanchen shift and the thickness of the adsorptive layer under test at this operating angle is illustrated in FIG. 21. The thickness sensing sensitivity under this operating condition can be as high as 3.3×10^{-3 nm}/μm.

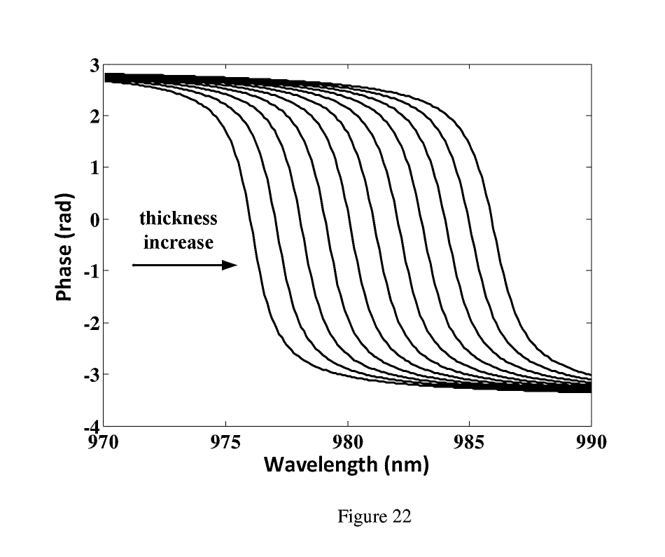

Applying the optical phase device into spectral phase sensing detection, the operating angle is set to 66 degrees. Supposing that the wavelength range of the input broadband beam is 970-990 nm, the relationship between the spectral phase change at this operating angle and the thickness of the adsorptive layer under test at this operating angle is shown in FIG. 22, wherein the thickness of the adsorptive thin layer under test varies from 5 nm to 15 nm with a step size of 1 nm.

A method of determining the refractive index of a test sample comprising the steps of: a) directing a monochromatic beam with an operation angular range of [θ1, θ2] at an optical phase device which includes: a transparent dielectric substrate; a multilayer stack of dielectrics including at least a first dielectric media and a second dielectric media where the refractive index of the first dielectric media is not equal to the refractive index of the second dielectric media; and a buffer layer which forms a first interface with a test sample, where the state of polarization of the monochromatic beam is fixed; where the total internal reflection occurs at the first interface producing an output beam; where the refractive index of the transparent dielectric substrate is larger than the refractive index of the test sample; where the refractive indices of the two or more dielectric media are larger than the refractive index of the test sample; where the refractive index of the buffer layer is larger than the refractive index of the test sample; and b) detecting the non-specular reflection parameters of the output beam; and c) determining based on the non-specular reflection parameters one or more parameters selected from the group consisting of refractive index, change in refractive index, loss of the test sample, and change in loss of the test sample.

A method of determining the refractive index of a test sample comprising the steps of: a) directing a polychromatic beam, where the polychromatic beam has a spectrum distribution in a wavelength range [λ_{inc1}, λ_{inc 2}] within an operation angular range of [θ1, θ2] at an optical phase device which includes: a transparent dielectric substrate; a multilayer stack of dielectrics including at least a first dielectric media and a second dielectric media where the refractive index of the first dielectric media is not equal to the refractive index of the second dielectric media; and a buffer layer which forms a first interface with a test sample; where the light source generates a polychromatic beam and θ2=θ1+1/δ, as δ approaches ∞, and fixing the incident angle at θ, where the refractive index of the transparent dielectric substrate is larger than the refractive index of the test sample, where the refractive indices of the two or more dielectric media are larger than the refractive index of the test sample, and where the refractive index of the buffer layer is larger than the refractive index of the test sample; and b) adjusting the polarization of the polychromatic beam using a polarization control device such that the total internal reflection occurs at the first interface producing an output beam; and c) detecting one or both the spectrum and time domain reflection parameters of the output beam; and d) determining based on one or both the spectrum and the time domain reflection parameters one or more parameters selected from the group consisting of refractive index, change in refractive index, loss of the test sample, and change in loss of the test sample.

A method of determining the refractive index or thickness of a test sample comprising the steps of: a) directing a polychromatic beam, where the beam has a spectrum distribution in a wavelength range [λ_{inc1}, λ_{inc 2}] within an operation angular range of [θ1, θ2] at an optical phase device which includes: a transparent dielectric substrate; a multilayer stack of dielectrics including at least a first dielectric media and a second dielectric media where the refractive index of the first dielectric media is not equal to the refractive index of the second dielectric media; and a buffer layer which forms a first interface with an external medium, where the external medium comprises a layer of a test sample and a bulk cladding medium, where the layer forms a first interface with the optical phase device, and the opposite side of the layer forms a second interface with the bulk cladding medium, where the first interface is parallel to the second interface and the total internal reflection occurs on the second interface, where the refractive index of the transparent dielectric substrate is larger than the refractive index of the bulk cladding medium, where the refractive indices of the two or more dielectric media are larger than the refractive index of the bulk cladding medium, and where the refractive index of the buffer layer is larger than the refractive index of the bulk cladding medium, and fixing the incident angle at θ, where θ2=θ1+1/δ, as δ approaches ∞; and b) adjusting the polarization of the polychromatic beam using a polarization control device such that the total internal reflection occurs at the first interface producing an output beam; c) detecting one or both the spectrum and time domain reflection parameters of the output beam; and d) determining based on one or both the spectrum and the time domain reflection parameters one or more parameters selected from the group consisting of refractive index, change in refractive index, thickness of the test sample, change in thickness of the test sample, loss of the test sample, and change in loss of the test sample.

A dispersion control system comprising: a) an optical phase device, which includes: a transparent dielectric substrate; a multilayer stack of dielectrics including two or more dielectric media with different refractive indices; a buffer layer which is adjacent to an external medium; and an optical coupler; and b) a light beam with a specified frequency distribution, where the light beam is normally incident onto a first surface of the optical coupler, where the optical phase device is adjacent to a second surface of the optical coupler, where the second surface is not parallel to the first surface, where the light beam incident onto the first surface of the optical phase device is reflected one or more times through the optical coupler and reflector, where the angular range of the light beam onto the optical phase device is [θ1, θ2], where the refractive index of the transparent dielectric substrate is larger than the refractive index of the external medium, where the refractive indices of the two or more dielectric media are larger than the refractive index of the external medium, where the refractive index of the buffer layer is larger than the refractive index of the external medium and where the optical phase device has a phase variation within the angular range [α, β], and max(α, γ)<θ1<θ2<β.

A sensing system comprising: a) a monochromatic light source; b) one or more polarization control devices; c) an optical phase device including: a transparent dielectric substrate; a multilayer stack of dielectrics including at least a first dielectric media and a second dielectric media where the refractive index of the first dielectric media is not equal to the refractive index of the second dielectric media; and a buffer layer which forms a first interface with an external medium including a test sample, where the light source is directed at the optical phase device in an angular range [θ1, θ2]; and d) an optical detector, where the device has a phase variation within the angular range [α, β], where the critical angle for total internal reflection (γ) is less than β, and where max (α, γ)<θ1<θ2<β.

A sensing system comprising: (a) a light source comprising a polychromatic beam; (b) one or more polarization control devices; (c) an optical phase device including: a transparent dielectric substrate; a multilayer stack of dielectrics including at least a first dielectric media and a second dielectric media where the refractive index of the first dielectric media is not equal to the refractive index of the second dielectric media; and a buffer layer which forms a first interface with an external medium including a test sample, where the light source is directed at the optical phase device in an angular range [θ1, θ2]; and (d) an optical detector, where the device has a phase variation within the angular range [α, β], where the critical angle for total internal reflection (γ) is less than β, and where max (α, γ)<θ1<θ2<β and where θ2=θ1+1/δ, as δ approaches ∞.

A sensing system comprising: a) a light source; b) one or more polarization control devices; c) an optical phase device including: a transparent dielectric substrate; a multilayer stack of dielectrics including at least a first dielectric media and a second dielectric media where the refractive index of the first dielectric media is not equal to the refractive index of the second dielectric media; and a buffer layer which forms a first interface with a test sample, where the light source is directed at the optical phase device in an angular range [θ1, θ2]; and d) an optical detector, where the device has a phase variation within the angular range [α, β], where the critical angle for total internal reflection (γ) is less than β, and where max (α, γ)<θ1<θ2<β, where the total internal reflection occurs on the first interface, where the refractive index of the transparent dielectric substrate is larger than the refractive index of the test sample, where the refractive indices of the two or more dielectric media are larger than the refractive index of the test sample, and where the refractive index of the buffer layer is larger than the refractive index of the test sample.

A sensing system comprising: a) a light source; b) one or more polarization control devices; c) an optical phase device including: a transparent dielectric substrate; a multilayer stack of dielectrics including at least a first dielectric media and a second dielectric media where the refractive index of the first dielectric media is not equal to the refractive index of the second dielectric media; and a buffer layer which forms a first interface with an external medium including a test sample, where the light source is directed at the optical phase device in an angular range [θ1, θ2]; and d) an optical detector, where the device has a phase variation within the angular range [α, β], where the critical angle for total internal reflection (γ) is less than β, and where max (α, γ)<θ1<θ2<β, where the external medium comprises a layer of a test sample and a bulk cladding medium, where the layer forms a first interface with the optical phase device, and the opposite side of the layer forms a second interface with the bulk cladding medium, where the first interface is parallel to the second interface and the total internal reflection occurs on the second interface, where the refractive index of the transparent dielectric substrate is larger than the refractive index of the bulk cladding medium, where the refractive indices of the two or more dielectric media are larger than the refractive index of the bulk cladding medium, and where the refractive index of the buffer layer is larger than the refractive index of the bulk cladding medium.

The embodiments illustrated in the drawings are intended to illustrate, but not to limit, the invention. Though the invention is described in detail with reference to the embodiments, it will be appreciated by those skilled in the art that any modification or equivalent change to the technical solution of the invention does not depart from the spirit and scope of the invention, and is included in the scope of the appended claims of the invention.

What is claimed is:

1. A sensing system comprising:
a) a light source;
b) one or more polarization control devices;
c) an optical phase device including:
a transparent dielectric substrate;
a multilayer stack of dielectrics including at least a first dielectric media and a second dielectric media where the refractive index of the first dielectric media is not equal to the refractive index of the second dielectric media; and
a buffer layer which forms a first interface with an external medium including a test sample, where the light source is directed at the optical phase device in an angular range [θ1, θ2]; and
d) an optical detector, where the device has a phase variation within the angular range [α, β], where the critical angle for total internal reflection (γ) is less than β, and where max (α, δ)<θ1<θ2<β.

2. The sensing system of claim 1, where the light source generates a monochromatic beam.

3. The sensing system of claim 1, where the light source generates a polychromatic beam and θ2=θ1+1/δ, as δ approaches ∞.

4. The sensing system of claim 1, where the external medium comprises the test sample, and the total internal reflection occurs on the first interface, where the refractive index of the transparent dielectric substrate is larger than the refractive index of the test sample, where the refractive indices of the two or more dielectric media are larger than the refractive index of the test sample, and where the refractive index of the buffer layer is larger than the refractive index of the test sample.

5. The sensing system of claim 1, where the external medium comprises a layer of a test sample and a bulk cladding medium, where the layer forms a first interface with the optical phase device, and the opposite side of the layer forms a second interface with the bulk cladding medium, where the first interface is parallel to the second interface and the total internal reflection occurs on the second interface, where the refractive index of the transparent dielectric substrate is larger than the refractive index of the bulk cladding medium, where the refractive indices of the two or more dielectric media are larger than the refractive index of the bulk cladding medium, and where the refractive index of the buffer layer is larger than the refractive index of the bulk cladding medium.

6. A method of determining the refractive index or the thickness of a test sample comprising the steps of:
a) directing a monochromatic beam with an operation angular range of [θ1, θ2] at an optical phase device which includes:
a transparent dielectric substrate;
a multilayer stack of dielectrics including at least a first dielectric media and a second dielectric media where the refractive index of the first dielectric media is not equal to the refractive index of the second dielectric media; and
a buffer layer which forms a first interface with an external medium, where the external medium comprises a layer of a test sample and a bulk cladding medium, where a proximal side of the layer forms a first interface with the optical phase device, where the distal side of the layer forms a second interface with the bulk cladding medium, where the first interface is parallel to the second interface, where the refractive index of the transparent dielectric substrate is larger than the refractive index of the bulk cladding medium, where the refractive indices of the two or more dielectric media are larger than the refractive index of the bulk cladding medium, and where the refractive index of the buffer layer is larger than the refractive index of the bulk cladding medium, where the layer is a thin film, where the state of polarization is fixed, where the total internal reflection occurs at the second interface producing an output beam; and
b) detecting the non-specular reflection parameters of the output beam; and
c) determining based on non-specular reflection parameters one or more parameters selected from the group consisting of refractive index, change in refractive index, thickness of the test sample, change in thickness of the test sample, loss of the test sample and the change in loss of the test sample.

7. The method of claim 6, where the non-specular reflection parameters are selected from the group consisting of spatial lateral displacement, longitudinal displacement, angular shift and change in beam shape.

8. The method of claim 6, where the incident monochromatic beam is a quasi-parallel beam whose incident angle is centered at θ, and its divergent angular range is [θ−Δθ, θ+Δθ], where, max (α, γ)<θ−Δθ<θ+Δθ<β.

9. A method of determining the refractive index of a test sample comprising the steps of:
a) directing a polychromatic beam, where the beam has a spectrum distribution in a wavelength range [λ_{inc1}, λ_{inc 2}], within an operation angular range of [θ1, θ2] at an optical phase device which includes:
a transparent dielectric substrate;
a multilayer stack of dielectrics including at least a first dielectric media and a second dielectric media where the refractive index of the first dielectric media is not equal to the refractive index of the second dielectric media; and
a buffer layer which forms a first interface with an external medium, where the light source generates a polychromatic beam and θ2=θ1+1/δ, as δ approaches ∞, and fixing the incident angle at θ; where the external medium is made up of a test sample, where the refractive index of the transparent dielectric substrate is larger than the refractive index of the test sample, where the refractive indices of the two or more dielectric media are larger than the refractive index of the test sample, and where the refractive index of the buffer layer is larger than the refractive index of the test sample; and
b) adjusting the polarization of the polychromatic beam using a polarization control device such that the total internal reflection occurs at the second interface producing an output beam; and
c) detecting one or both the spectrum and time domain reflection parameters of the output beam; and
d) determining based on one or both the spectrum and the time domain reflection parameters one or more parameters selected from the group consisting of refractive index, change in refractive index, loss of the test sample, and change in loss of the test sample.

10. A method of determining the refractive index or the thickness of a test sample comprising the steps of:
a) directing a polychromatic beam, where the beam has a spectrum distribution in a wavelength range [λ_{inc1}, λ_{inc 2}], within an operation angular range of [θ1, θ2] at an optical phase device which includes:
a transparent dielectric substrate;
a multilayer stack of dielectrics including at least a first dielectric media and a second dielectric media where the refractive index of the first dielectric media is not equal to the refractive index of the second dielectric media; and
a buffer layer which forms a first interface with an external medium, where the light source generates a polychromatic beam and θ2=θ1+1/δ, as δ approaches ∞, and fixing the incident angle at θ; where the external medium comprises a layer of a test sample and a bulk cladding medium, where a proximal side of the layer forms a first interface with the optical phase device, where the distal side of the layer forms a second interface with the bulk cladding medium, where the first interface is parallel to the second interface, where the refractive index of the transparent dielectric substrate is larger than the refractive index of the bulk cladding medium, where the refractive indices of the two or more dielectric media are larger than the refractive index of the bulk cladding medium, and where the refractive index of the buffer layer is larger than the refractive index of the bulk cladding medium; and
b) adjusting the polarization of the polychromatic beam using a polarization control device such that the total internal reflection occurs at the second interface producing an output beam; and
c) detecting one or both the spectrum and time domain reflection parameters of the output beam; and
d) determining based on one or both the spectrum and the time domain reflection parameters one or more parameters selected from the group consisting of refractive index, change in refractive index, thickness of the test sample, change in thickness of the test sample, loss of the test sample, and change in loss of the test sample.
